(19) United States
(12) Patent Application Publication
(10) Pub. No.: US 2002/0069279 A1
(43) Pub. Date: Jun. 6, 2002

(54) Apparatus and method for routing a transaction based on a requested level of service

(76) Inventors: Francisco J. Romero, Plano, TX (US); Raja Daoud, Santa Clara, CA (US)

Correspondence Address: HEWLETT-PACKARD COMPANY, Intellectual Property Administration, P. O. Box 272400, Fort Collins, CO, 80527-2400, US

(21) Appl. No.: 09/751,011

(22) Filed: Dec. 29, 2000

(51) Int. Cl. G06F 15/173

(52) U.S. Cl. 709/225

(57) ABSTRACT

An apparatus and method for routing a transaction to a server based on a requested level of service associated with the transaction. The transaction is preferably packetized and the requested level of service is indicated by a service tag associated therewith as part of the packetized transaction. A load balancer monitors the service level provided by each server in a server pool and generates a server index. The server index at least identifies each server and the corresponding service level. When the transaction is received at the load balancer, the service tag is read to determine the requested level of service. The load balancer selects a server from the server pool using the server index to determine which server is best providing the requested level of service and the transaction is then directed to that server. Alternatively, the load balancer can direct the transaction to a server within a group of servers that best provides the requested level of service.

### RELATED APPLICATION

This patent application is related to co-owned patent application for APPARATUS AND METHOD FOR IDENTIFYING A REQUESTED LEVEL OF SERVICE FOR A TRANSACTION, having the same filing date and identified by Hewlett Packard Docket No. HP 10002669-1.

### FIELD OF THE INVENTION

The invention pertains to routing a transaction to a server which can best provide a requested level of service for the transaction.

### BACKGROUND OF THE INVENTION

Server pools having multiple servers are often provided on networks, including the Internet, to handle large volumes of transactions (i.e., “requests to process data”) thereon. Load balancing tools are used to direct incoming transactions to the server in the server pool in such a way that the traffic is balanced across all the servers in the pool. As such, the transactions can be processed faster and more efficiently.

One approach to load balancing simply involves routing each new transaction to a next server in the server pool (i.e., the “round-robin” approach). However, this approach does not distinguish between available servers and those which are down or otherwise unavailable. Therefore, transactions directed to unavailable servers are not processed in a timely manner, if at all. Other approaches to load balancing involve routing transactions to the next available server. That is, an agent monitors a pool of servers for failure and tags servers that are unavailable so that the load balancer does not route transactions to an unavailable server. However, this approach is also inefficient, still not necessarily routing transactions to the server that is best able to process the transaction. For example, a large transaction (e.g., a video clip) may be directed to a slow server even though there is a faster server available, because the slow server is identified as being the “next available” server when the transaction arrives at the load balancer. Likewise, a low priority transaction (e.g., an email) may be directed to the fast server simply based on the order that the servers become or are considered available.

A more current approach uses a combination of system-level metrics to route transactions and thus more efficiently balance the incoming load. The most common metrics are based on network proximity. For example, the 3/DNS load balancing product (available from F5 Networks, Inc., Seattle, Wash.) probes the servers and measures the packet rate, Web-request completion rate, round-trip time and network topology information. Also for example, the Resonate Global Dispatch load balancing product (available from Resonate, Inc., Sunnyvale, Calif.) uses latency measurements for load balancing decisions.

However, while system metric approaches measure server characteristics, the transaction is not routed based on service levels required by or otherwise specific to the transaction. That is, the transaction is not routed based on the transaction size, the originating application, the priority of the transaction, the identification of the user generating the transaction, etc. Instead, the transaction is routed to the fastest available server when the transaction arrives at the load balancer. As such, the video clip and the low priority email, in the example given above, still may not be efficiently routed to the servers for processing. For example, if the low priority email arrives at the load balancer when the fastest server is available, the email will be routed to the fastest server, thus leaving only slower servers available when the high priority video clip later arrives at the load balancer.

### SUMMARY OF THE INVENTION

The inventors have devised a method and apparatus to route a transaction to a server that can best provide a requested level of service associated with the transaction.

A load balancer preferably monitors the service level provided by each server in a server pool and generates a server index. Alternatively, the server index can be based on known capabilities and/or predicted service levels of the servers in the server pool. In any event, the server index at least identifies each server and the corresponding service level. The corresponding service level of each server can be based on the server meeting the service level objectives of a single user, a user group (e.g., the accounting department), or a transaction group (e.g., email).

The transaction (e.g., email, application-specific data, etc.) is preferably packetized. The packetized transaction is modified to include a service tag (e.g., a single or multi-bit packet) indicating the requested level of service associated with the transaction. The service tag can indicate the requested level of service as a predefined service category (e.g., premium, standard, low), a user identification (e.g., user1, user2, administrator), a transaction type (e.g., email, video), etc. In addition, the service tag can be user-defined, set by the application submitting the transaction, set by an administrator, based on the time (e.g., weekday or weekend), based on the type of transaction, etc.

When the transaction is received at the load balancer, the service tag is read to determine the requested level of service. The load balancer selects a server from the server pool using the server index to determine which server can best provide the requested level of service, and the transaction is then directed to that server. For example, where the requested level of service associated with the transaction is a scale value of “50”, the load balancer selects the server providing a corresponding service level nearest the requested level of service, such as a scale value of “48”. Alternatively, the load balancer can direct the transaction to a server within a group of servers wherein each is best able to provide the requested level of service. For example, a category of service can be requested, such as “premium”, and the load balancer thus selects any server from the group of servers providing a corresponding service level of “premium”.

As such, the transaction is efficiently routed to a server based on service level information specific to the transaction. Thus for example, a low priority transaction (e.g., an email) may arrive at the load balancer before a high priority transaction (e.g., a video clip) when the fastest server is available. However, the low priority transaction is identified as such and routed to a slower server. Thus, the fastest server is available when the high priority transaction arrives at the load balancer, even so it arrives later than the low priority transaction.

These and other important advantages and objectives of the present invention will be further explained in, or will become apparent from, the accompanying description, drawings and claims.

### BRIEF DESCRIPTION OF THE DRAWINGS

Illustrative and presently preferred embodiments of the invention are illustrated in the drawings in which:

FIG. 1 shows a first embodiment of a load balancer for routing a transaction to a server;

FIG. 2 shows a packetized transaction having a service tag associated therewith for requesting a level of service for the transaction;

FIG. 3 shows a second embodiment of a load balancer for routing the transaction of FIG. 2 to a server based on the requested level of service indicated by the service tag;

FIG. 4 illustrates a server index identifying servers and the corresponding service level of each server that can be used by the load balancer in FIG. 3;

FIG. 5 shows a load balancer routing the transaction of FIG. 2 to a server within a group of servers each best able to provide the requested level of service indicated by the service tag;

FIG. 6 illustrates a server index identifying groups of servers and the corresponding service level of each group that can be used by the load balancer in FIG. 5; and

FIG. 7 is a flow chart showing a method for routing the transaction of FIG. 2 to a server, as in FIG. 3 and FIG. 5.

### DESCRIPTION OF THE PREFERRED EMBODIMENT

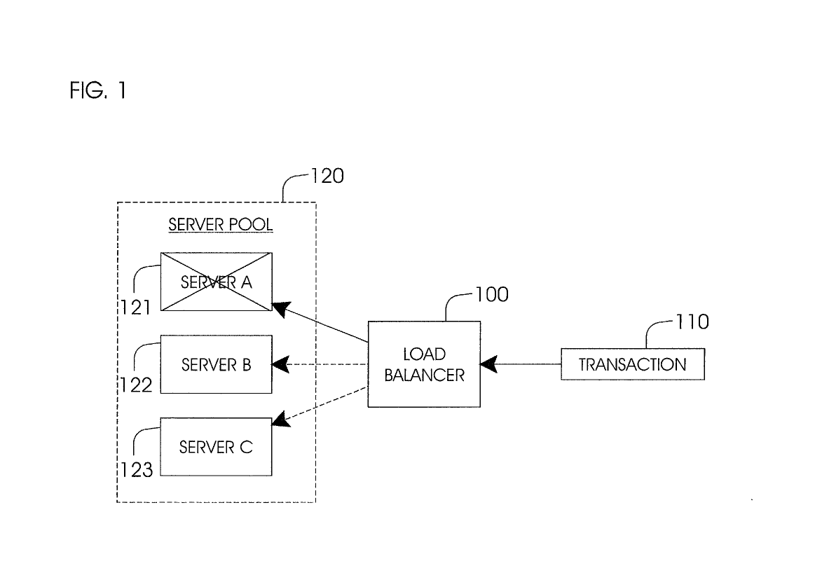

FIG. 1 shows a load balancer 100 for routing a transaction 110 to a number of (i.e., one or more) servers 121, 122, 123 in a server pool 120. For purposes of illustration, Server A is unavailable as indicated by the “X” in FIG. 1. Using a simple “round-robin” approach, the load balancer 100 receives a next transaction 110 and directs the transaction 110 to the next server in the server pool 120 (i.e., the last server to have received a transaction). For example, where the previous transaction is directed to server 123 (Server C), the next server is server 121 (Server A) even where the server 121 (Server A) is unavailable as shown in FIG. 1, and so forth. Alternatively, the load balancer 100 directs the transaction 110 to the next available server in the server pool 120. That is, an agent (e.g., suitable program code) monitors each of the servers 121, 122, 123 in the server pool 120 and labels a server that has failed, shut down, or is otherwise unavailable, as “unavailable” (e.g., using a suitable computer readable tag). Thus, the load balancer 100 recognizes a server that has been labeled “unavailable” and does not route transactions to the unavailable server. For example, where the previous transaction was directed to server 123 (Server C) and server 121 (Server A) is indicated as being “unavailable”, the next server is server 121 (Server A). However, the next available server is server 122 (Server B). Therefore, in this example the transaction 110 is directed to server 122 (Server B). Alternatively, the load balancer 100 can direct the transaction 110 to the “fastest” available server in the server pool 120. For example, where server 121 (Server A) generally provides a fast turn-around but is labeled “unavailable”, server 122 (Server B) provides a medium turn-around, and server 123 (Server C) provides a slow turn-around, the transaction 110 is routed to server 122 (Server B). That is, although server 121 (Server A) is generally the fastest server in the server pool 120, server 121 (Server A) is unavailable, therefore leaving server 122 (Server B) as the fastest available server. However, none of these approaches direct the transaction 110 to a server 121, 122, 123 based on parameters specific to the transaction 110.

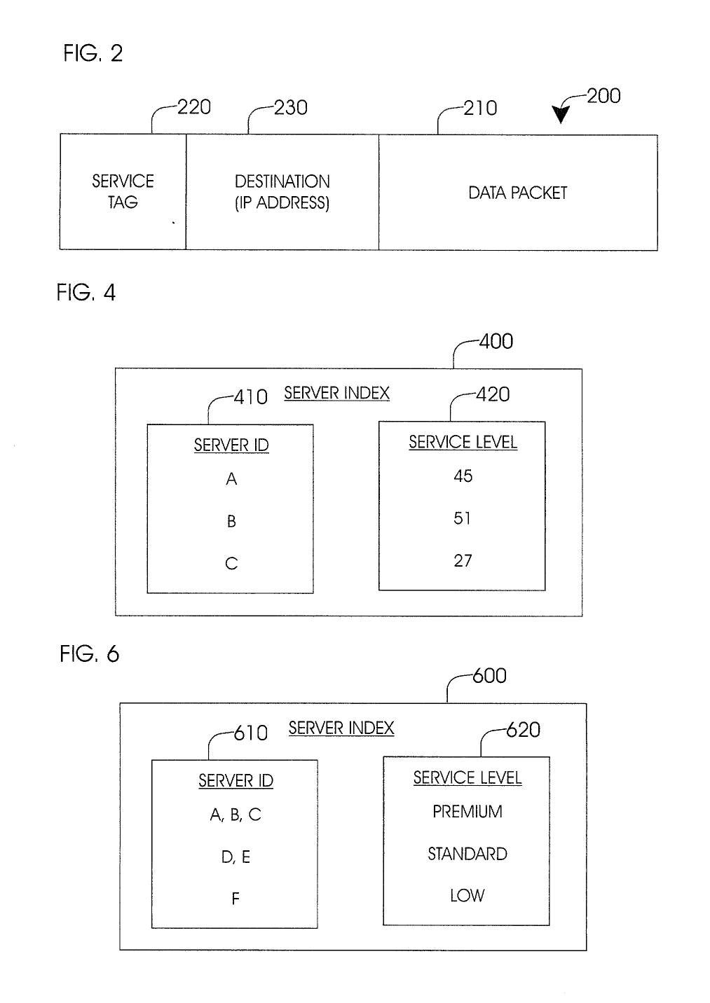

FIG. 2 shows a packetized transaction 200. The packetized transaction 200 includes at least a data packet 210 (i.e., the data to be processed) and a service tag 220. Optionally, the transaction 200 can include other fields, such as, but not limited to a destination 230 (e.g., an IP address). The data packet 210 can include any data that is to be processed in any number of ways, such as an email message to be delivered to a recipient, a uniform resource locator (URL) requesting a hypertext markup language (HTML) page from the corresponding Internet site, data to be stored in a network area storage (NAS) device, spreadsheet data for tabulation, a portion thereof to be reassembled upon reaching the destination server, etc. The service tag 220 is preferably a single or multi-bit packet associated with the data packet 210, the value of which indicates a requested level of service for the transaction 200.

It is understood that the service tag 220 can include any number of bits and can be any suitable indicator. For example, the service tag 220 can be a numeric value such as a “one”, indicating high priority, or a “zero”, indicating low priority. Alternatively, the service tag 220 can indicate the requested level of service as a predefined service category (e.g., premium, standard, low). Or the requested level of service can be a specific parameter (e.g., processing speed, processing capacity, etc.). Likewise, the service tag 220 can indicate a preferred level of service (e.g., “premium”) with a backup level of service (e.g., “standard”) where the preferred level of service is unavailable. It is also understood that the requested level of service can be a relative ranking (e.g., a number on a scale of one to ten, a category of service, etc.) based on information about the monitored servers obtained by polling the servers, service specifications, etc. That is, the servers can be ranked relative to one another, relative to the types of transactions processed, etc., and the requested level of service based on these parameters. In addition, the requested level of service can be user-defined, set by the application submitting the transaction, set by an administrator, etc. The requested level of service can be based on the time (e.g., weekday or weekend), a user identification (e.g., user1, user2, administrator), a transaction type (e.g., email, video), a combination thereof, etc.

The requested level of service may be assigned to the transaction 200, for example, based on time sensitivity, with data that is time sensitive assigned a higher priority than data that is not time sensitive. Or for example, large processing requests can be assigned to faster servers. As yet another example, users that generally require faster processing speeds (the CAD department) can be assigned faster servers than those who require the servers only to back up their data. A transaction that would normally be assigned to a slow server during business hours can be assigned to a faster server during evening hours and on weekends. In addition, the service tag may be assigned at any suitable device along the transaction path, such as by the originating computer, an intermediary computer, a gateway, a router, etc.

It is understood that the above examples are merely illustrative of the requested level of service indicated by the service tag 220 that can be associated with a data packet 210 (e.g., assigned to the transaction 200) and other examples are contemplated as within the scope of the present invention.

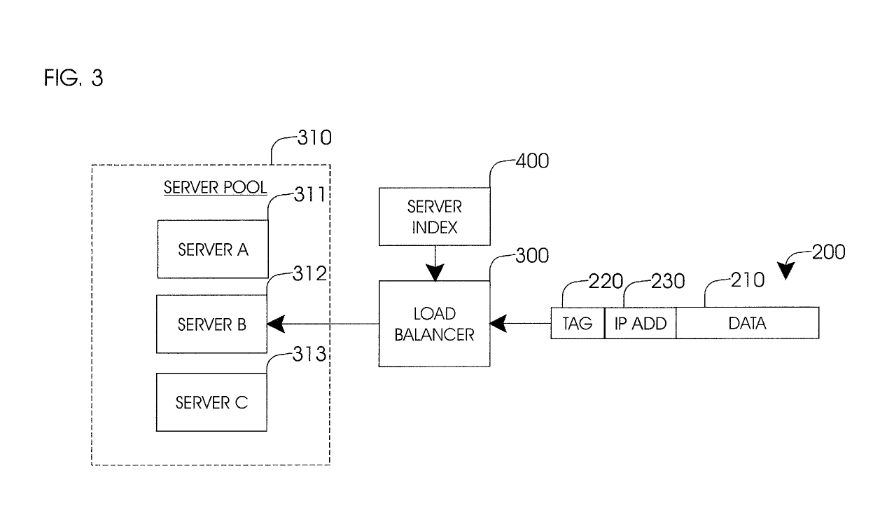

FIG. 3 shows the transaction 200 received at a load balancer 300 and directed to a server 311, 312, 313 in a server pool 310 that is best able to process the transaction 200 based on the requested level of service indicated by the service tag 220. In FIG. 3, the load balancer 300 selected server 312 (Server B) as the server that is best able to process the transaction 200, using the service tag 220 and the server index 400 (FIG. 4).

The server index 400 (FIG. 4) is preferably a multi-dimensional array (e.g., a database or “lookup table”) stored in a memory accessible by the load balancer 300. The server index 400 includes at least a server identification (ID) 410 and a corresponding service level 420 for each server 311, 312, 313 in the server pool 320 that is managed by the load balancer 300. The server ID 410 can be the server IP address, a path, or any other suitable means that the load balancer 300 can use to identify a server 311, 312, 313 and direct a transaction 200 thereto. Other data related to the various servers can also be included in the server index, such as that status of a particular server (e.g., available, unavailable, current load), alternative or backup servers or pools of servers, etc.

When the transaction 200 is received by the load balancer 300, the service tag 220 is read using suitable program code. The load balancer 300 then accesses the server index 400 to determine (e.g., using suitable program code) the server in the server pool 310 that is best providing the requested level of service associated with the transaction 200 (i.e., as indicated by the service tag 220). For example, where the service tag 220 indicates a requested level of service having a scale value of “50”, the server index 400 indicates that server 312 (Server B) is providing a corresponding service level 420 having a scaled value of “51”, while the other servers 311 and 313 are providing lower levels of service. Hence, the load balancer 300 directs the transaction to server 311 (Server B), as shown in FIG. 3. As another example, where the service tag 220 indicates the requested level of service is a scaled value of “25”, the load balancer 300 directs the transaction 200 to server 313 (Server C), which is providing a corresponding service level 420 having a scaled value of “27”, as indicated by the server index 400.

It is to be understood that the term “best”, as that term is used herein with respect to the server best able to provide the requested level of service, is defined to mean “best as determined by the program code of the load balancer”, and may be interpreted by a load balance as, for example, “nearest” or “meeting” the requested level of service. Thus, even where the requested level of service and the service level actually being provided are at opposite ends of a spectrum (e.g., the requested level of service is a scaled value of “50” but the service levels being provided by the servers range from scaled values of “5” to “10”), the server providing a service level nearest to that requested (e.g., a service level having a scaled value of “10”) is considered to be “best” able to provide the requested level of service. However, it is also to be understood that where the disparity between the requested level of service and the service level being provided is unacceptable (i.e., based on a predetermined level of acceptability, such as more than “10” scale values difference), the load balancer 300 can direct the transaction to the server best able to provide the requested service level, but also return a warning signal (e.g., an email, an error message, etc.) to the requestor (e.g., an administrator, the user, the originating application, etc.) notifying the requester of the disparity. Alternatively, the load balancer 300 can redirect the transaction 200 to another load balancer that is monitoring another pool of servers, the load balancer 300 can “bounce” the transaction 200 altogether, etc.

It is also to be understood that the term “server” as used herein can be any computer or device that manages resources, such as a file server, a printer server, a network server, a database server, etc. In addition, the servers can be dedicated or the servers can be partitioned (i.e., have multiprocessing capability), in which case the term “server” may instead refer to software that is managing resources rather than to an entire computer or other hardware device.

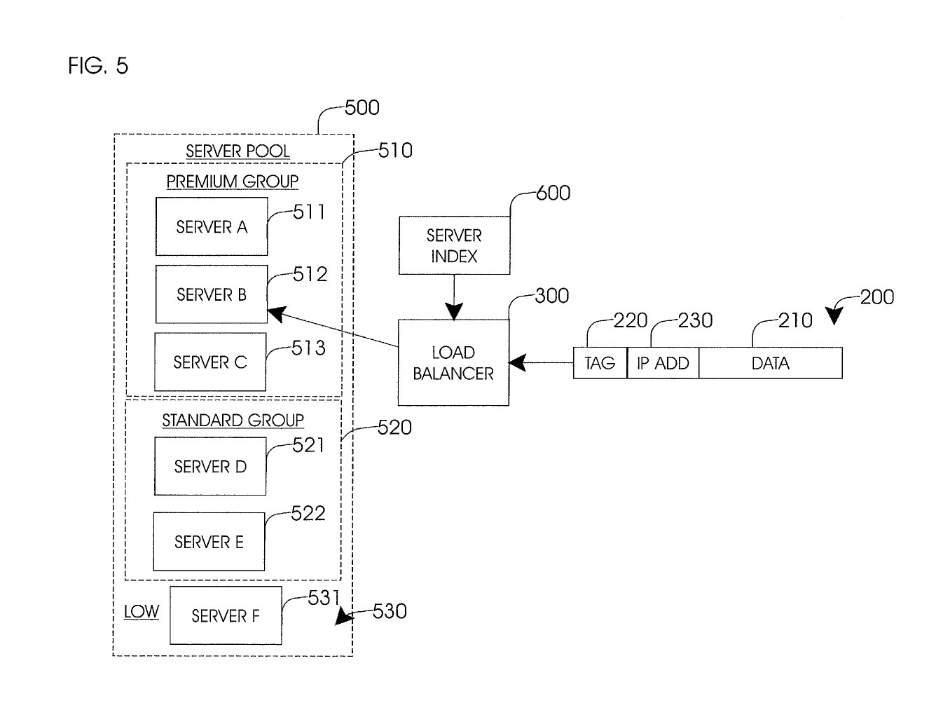

In FIG. 5, the server pool 500 includes a premium group 510, a standard group 520, and a low priority group 530. The servers 511, 512, and 513 (A, B, and C, respectively) are part of the “premium” group 510. For example, the premium group 510 can include high-speed, high-capacity servers. In addition, the premium group 510 can include additional servers and backup servers so that there is always an available server in this group. Access to these servers can be reserved for a department with high demand requirements (e.g., the CAD department), for high priority transactions, for customers paying a fee to access these servers, etc. The standard group 520 can include average-speed, average capacity servers. Access to these servers 521, 522 (D and E) can be designated for a sales/marketing department that requires only average processing capacity, or can also be available on a fee-basis. The “low priority” group 530 can include older and/or less expensive servers 531 that do not perform at the predetermined standards of the standard group 520 or the premium group 510. These servers 531 can be used for low-priority email, backup jobs, transactions requested during off-peak hours when timeliness is not as important, etc. These servers can be designated as a group 530, or simply be unclassified servers in the server pool 500.

It is to be understood that any number of groups can be designated. The manner in which groups are designated can include static parameters such as processing speed, capacity, server proximity, etc. However, preferably the groups 510, 520, 530 are dynamically designated based on monitored performance of the individual servers. For example, where a “premium” server (e.g., 511) is not performing to a predetermined standard, it can be reclassified as a standard or low priority server (i.e., in group 530), whereas a standard server (e.g., 521) that has recently been upgraded can be reclassified as a premium server (i.e., in group 510). Likewise, the invention disclosed herein is not to be limited by the groups 510, 520, 530 shown in FIG. 5. For example, more or fewer groups can be used, servers can be further subdivided within the groups, the groups can be identified by means other than the labels “premium”, “standard”, and “low”, etc.

The service level being provided by each server can be based on, as illustrative but not limited to, the server meeting the service level objectives of a single user, a user group (e.g., the accounting department), or a transaction type (e.g., email). That is, preferably the load balancer 300 (or suitable software/hardware agent) monitors the service level provided by each server in the server pool to generate the server index. For example, the load balancer 300 can measure or track processing parameters of a server (e.g., total processing time, processor speed for various transactions, etc.) with respect to a single user, a user group, a transaction type, etc. Alternatively, the server index can be based on known capabilities (e.g., processor speed, memory capacity, etc.) and/or predicted service levels of the servers in the server pool (e.g., based on past performance, server specifications, etc.). Or for example, the load balancer 300 can access multiple server indexes, wherein each index is based on a different set of monitored server parameters. A group ID or the like associated with a transaction can then be used as the basis for the load balancer 300 accessing a particular server index.

In any event, it is understood that the service level provided by each server in the server pool can be formatted similar to the requested level of service. Alternatively, program code for translation can be implemented (e.g., at the load balancer 300) to convert between formats. For example, a category of service level, such as “premium”, associated with the transaction 200 can be converted to a scale value, such as “50”, associated with a server or group of servers in the server pool.

When the transaction 200 is received at the load balancer 300, the load balancer 300 reads the requested level of service from the service tag 220. Based on the server index 600 (FIG. 6), the load balancer 300 selects the server (e.g., 512) from the server group (e.g., 510) that is best providing the requested level of service (e.g., “premium”). That is, the server index 600 contains the server ID 610 and a corresponding level of service 620, similar to the server index 400 in FIG. 4. However, in server index 600, the server ID 610 is indicated as a group of servers. That is, Servers A, B, and C, are providing a “premium” level of service, Servers D and E are providing a “standard” level of service, and Server F is providing a low-priority level of service. Thus for example, where the service tag 220 indicates that the requested level of service is “premium”, the load balancer 300 directs the transaction 200 to any one of the servers 511, 512, 513 in the premium group 510. The load balancer can use conventional load balancing algorithms (e.g., next available, fastest available, or any other suitable algorithm) to select a specific server 511, 512, 513 within the premium group 510.

It is understood that the load balancing schemes shown in FIG. 3 and FIG. 5 are illustrative of the apparatus and method of the present invention and are not intended to limit the scope of the invention. Other configurations are also contemplated as being within the scope of the invention. For example, multiple load balancers can be networked to administer a single server pool or multiple server pools. Such a configuration allows a load balancer experiencing heavy use to transfer some or all of the transactions in bulk to another load balancer experiencing a lighter load. Or for example, a hierarchy of load balancers might administer the server pool. A possible hierarchical configuration could comprise a gatekeeping load balancer that directs transactions either to a load balancer monitoring a premium server pool or to a load balancer monitoring a standard server pool, and the individual load balancers can then select a server from within the respective server pool.

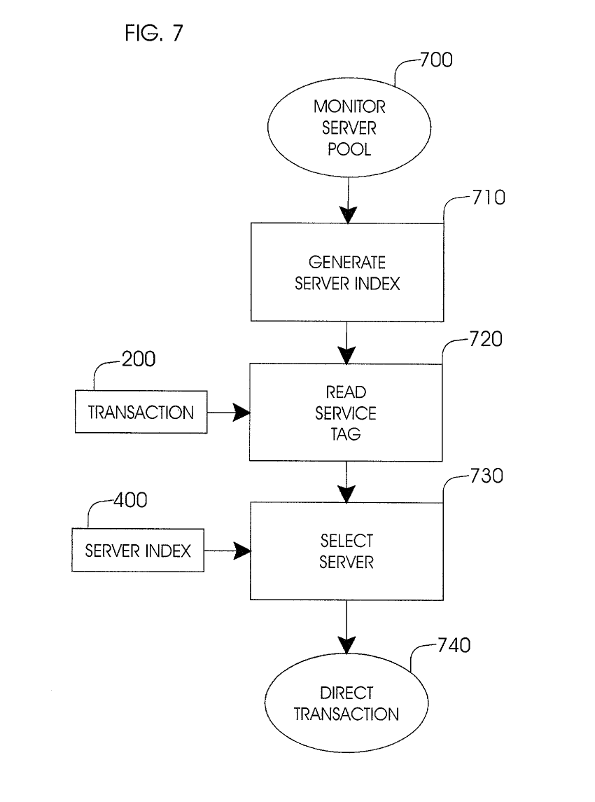

FIG. 7 shows a method for routing the transaction 200 to a server based on a requested level of service associated with the transaction 200 generated in step 710, using suitable program code and stored on a number of (i.e., one or more) suitable computer readable storage media. In step 700, the load balancer 300 (or a suitable software/hardware agent) monitors the server pool 320, 500 to determine the service level of each server in the server pool. In step 710, the load balancer 300 (or a suitable software agent) uses the monitored data to generate a server index (e.g., 400, 600) having at least the server ID (e.g., 410, 610) and the corresponding service level (e.g., 420, 620), including groups of servers where desired. In step 720, when a transaction 200 is received at the load balancer 300, the load balancer 300 (or suitable program code associated therewith) reads the requested level of service indicated by the service tag 220 associated with the transaction 200. In step 730, the load balancer 300 accesses the server index to select a server from the server pool that is best able to provide the requested level of service. Once a server has been selected, the load balancer 300 directs the transaction 200 to the selected server in the server pool in step 740.

It is understood that the method shown and described with respect to FIG. 7 is merely illustrative of a preferred embodiment. However, each step need not be performed under the teachings of the present invention. Step 710 can be modified or eliminated, as an example, where a server index is provided with a predetermined server ID and the corresponding service level is packaged with the load balancer 300. Likewise, the steps need not be performed in the order shown in FIG. 7. For example, the transaction 200 can be received and the service tag 220 read by the load balancer (as in step 720), followed by the load balancer 300 monitoring the server pool for a server providing the requested level of service (as in step 700). In such an example, it is also understood that a server index need not be generated at all (as in step 710) and that the load balancer can select a server dynamically (i.e., based on current server performance).

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. An apparatus for routing a transaction based on a requested level of service, comprising:
a number of computer readable storage media; and
computer readable program code stored in said number of storage media, comprising:
a) program code for reading said requested level of service from a service tag associated with said transaction; and
b) program code for directing said transaction to a server which can best provide said requested level of service.

2. An apparatus, as in claim 1, further comprising program code for monitoring service levels provided by each server in a server pool.

3. An apparatus, as in claim 1, further comprising program code for selecting said server from a group of servers that best provides said requested level of service.

4. An apparatus, as in claim 1, further comprising:
program code for generating a server index to identify said server and a corresponding service level; and
program code for selecting said server from said server index when said corresponding service level is best able to provide said requested level of service.

5. An apparatus, as in claim 4, wherein said program code for generating said server index further generates multiple server indexes, wherein each of said multiple server indexes is based on different server parameters.

6. An apparatus, as in claim 5, wherein said transaction indicates to said load balancer a particular server index to access from said multiple server indexes.

7. An apparatus, as in claim 4, further comprising program code for converting between a first format of said requested level of service and a second format of said corresponding service level identified by said server index.

8. An apparatus, as in claim 1, further comprising program code for redirecting said transaction to an alternate load balancer when a first load balancer is unable to provide said requested level of service.

9. An apparatus, as in claim 1, further comprising program code for bouncing said transaction when said server is unable to provide said requested level of service.

10. An apparatus, as in claim 1, further comprising program code for notifying an originator of said transaction of the service level provided.

11. A method for routing a transaction based on a requested level of service, comprising:
reading said requested level of service associated with said transaction; and
directing said transaction to a server that best provides said requested level of service.

12. A method, as in claim 11, further comprising monitoring service levels provided by each server in a server pool.

13. A method, as in claim 12, further comprising comparing said requested level of service with said monitored service level.

14. A method, as in claim 11, further comprising selecting said server from a group of servers best providing said requested level of service.

15. A method, as in claim 11, further comprising:
generating a server index;
selecting said server using said server index based on said requested level of service.

16. A method, as in claim 11, further comprising redirecting said transaction when said server is unable to provide said requested level of service.

17. A method, as in claim 11, further comprising bouncing said transaction when said server is unable to provide said requested level of service.

18. A method, as in claim 11, further comprising notifying an originator of said transaction of the service level provided.

19. An apparatus for routing a transaction based on a requested level of service, comprising:
means for reading said requested level of service associated with said transaction;
means for determining service levels provided by a number of servers; and
means for directing said transaction to one of said number of servers that best provides said requested level of service.

20. A method, as in claim 19, further comprising:
means for monitoring said number of servers;
means for determining said service level of said number of servers; and
means for selecting a server that best provides said requested level of service from said number of servers.
